(19) United States
(12) Patent Application Publication
(10) Pub. No.: US 2019/0204184 A1
(43) Pub. Date: Jul. 4, 2019

(54) VEHICLE TEST BENCH FOR CALIBRATING AND/OR TESTING SYSTEMS OF A VEHICLE, WHICH COMPRISE AT LEAST ONE CAMERA, AND METHOD FOR CARRYING OUT THE CALIBRATING AND/OR TESTS OF SYSTEMS OF A VEHICLE, WHICH COMPRISE AT LEAST ONE CAMERA

(71) Applicant: DÜRR Assembly Products GmbH, Püttlingen (DE)

(72) Inventors: Jörg Neumann, Reinsfeld (DE); Christian Petzinger, Heusweiler (DE); Holger-Thorsten Pfeil, Riegelsberg (DE); Thomas Tentrup, Merzig-Mechern (DE); Martin Wagner, Saarbrücken (DE); Rainer Weisgerber, Saarwellingen (DE)

(21) Appl. No.: 16/333,891

(22) PCT Filed: Sep. 15, 2017
(86) PCT No.: PCT/DE2017/100792

§ 371 Date: Mar. 15, 2019

(30) Foreign Application Priority Data
Sep. 16, 2016 (DE) 10 2016 117 444.0

(51) Int. Cl. G01M 17/007; G06T 7/80; G06T 7/593; H04N 13/246; G07C 5/08

(52) U.S. Cl. CPC G01M 17/007; G06T 7/85; G06T 2207/10012; H04N 13/246; G07C 5/0808; G06T 7/593

(57) ABSTRACT

The present invention relates to a vehicle test bench for calibrating and/or testing systems of a vehicle which comprise at least one camera. The vehicle test bench has a target position for the vehicle. At least one surface that reproduces an image display and/or shows an image display is assigned to the cameras of systems to be tested. A plurality of elements that absorb stray light are provided, which elements each consist of a wall-like boundary of the vehicle test bench, which reduces penetration of light into the vehicle test bench. A plurality of wall-like boundaries results in lateral delimitation of the vehicle test bench on all sides. A supporting structure is furthermore provided, comprising at least one elongate support element that is arranged above the vehicle, and adjustment means for moving at least one of the at least one surface reproducing an image display and/or showing an image display, and/or at least one unit for checking a radar sensor, and/or at least one unit for checking an optical distance sensor, and/or at least one unit for checking a night vision device of the vehicle in the horizontal direction along the at least one support element. A method is also described, in which two cameras, by means of which a three-dimensional structure is intended to be identified in a stereophotogrammetric evaluation, are tested in a coordinated manner by means of the individual images which the two cameras see in each case in order to identify the three-dimensional structure being displayed in a temporal sequence. The individual images of the two cameras may also be separated by means of the polarization direction of the light or different wavelengths.

### PRIOR APPLICATIONS

This application claims priority to International Patent Application No. PCT/DE2017/100792, filed on Sep. 15, 2017, which claims priority to German Patent Application No. DE 10 2016 117 444.0, filed on Sep. 16, 2016, the contents both of which are incorporated herein by reference.

### TECHNICAL FIELD

The present invention relates to a vehicle test bench for calibrating and/or testing systems of a vehicle which comprise at least one camera, and to a method for carrying out the calibration and/or tests of systems of a vehicle which comprise at least one camera.

### BACKGROUND

Cameras are employed at the front, at the sides and optionally also in the rear region of vehicles, inter alia for driver assistance systems. In this case, the cameras may also be provided in the upper region (roof region), and also for the underfloor region (in particular in the case of rough terrain). Said cameras are for example known in the form of lane departure warning systems or for identifying obstacles that may constitute a collision risk. In the case of said driver assistance systems, warnings are issued from the evaluation of the camera images, optionally taking account of the evaluation of further sensor signals, if an operating state is identified as critical. Cameras of this kind in addition play an increasing role in systems that are intended for autonomous driving of a vehicle. Systems of this kind must be capable of accurately identifying complex situations in order to be able to correctly intervene in the adjustment means of the vehicle (accelerating, braking, steering).

Relevant sensors are cameras, radar sensors and optical distance sensors. The radar sensors may be installed centrally in the front or in the tail (referred to in the following as a front radar sensor), or laterally in the front or in the tail (referred to in the following as lateral radar sensors) of the vehicle. The front radar sensors measure the region of the traffic lane of the vehicle (distance from objects or preceding or following vehicles). The lateral radar sensors relate to measuring objects and in particular also vehicles that are located laterally behind the traffic lane of the vehicle. Said lateral radar sensors can identify obstacles and other vehicles that become relevant in the event of a change of traffic lane. The optical distance sensors function for example on the basis of infrared technology.

The corresponding measuring equipment of the vehicle test bench should be referred to generally as targets in connection with this IP right. Said targets are different for the individual sensors of the vehicle. As will be explained in the following, the targets for the radar sensors may be stationary or pivotable/tiltable mirrors or plates, corner reflectors (referred to in the following simply as “mirrors”), or doppler generators. For the optical distance sensors, said targets may be what are known as light boxes.

In the case of the front radar sensors, it is important for said sensors to be appropriately oriented. For this purpose, radar beam-reflecting surfaces (mirrors) are generally used. Said mirrors have a defined orientation with respect to the orientation of the vehicle. When the front radar sensor is correctly calibrated, the radar beam reflected by the mirror again strikes the front radar sensor. When the mirror is aligned such that the perpendicular on the surface thereof is oriented towards the geometric travel axis of the vehicle, calibration can be carried out by means of the front radar sensor being adjusted such that the radar beam reflected by the mirror again strikes the front radar sensor. The adjustment of the radar sensors can be achieved by means of the radar sensor itself, or can be carried out by means of manual adjustment.

The lateral radar sensors are generally calibrated and tested by means of double generators. Said doppler generators are positioned in a specified direction with respect to the position of the vehicle and to the geometric driving axis of the vehicle. When calibrating and testing the lateral radar sensors, said radar sensors are calibrated by means of being adjusted such that the lateral radar sensors identify the doppler generators in the correct (i.e. in the specified) direction. A function test can also be carried out by means of the doppler generators, in that a moving object is simulated. It is possible to test whether the lateral radar sensor accurately identifies the simulated movement of the object.

It is clear that the front radar sensors can be calibrated and, in this case, also tested, using doppler generators as targets, to ascertain whether said sensors correctly identify the simulated speed of a preceding vehicle.

If the lateral radar sensors are intended only to be calibrated and not tested with respect to the function thereof, this can also be carried out using mirrors as targets.

What are known as light boxes are known for adjusting headlights of a vehicle. Said light boxes are positioned in front of the headlight so as to be at a specified orientation on the axis of symmetry of the vehicle. It is possible to check, using a light box of this kind, whether the beam direction of the vehicle headlight is adjusted correctly. Comparable measuring equipment can be used in order to check optical distance sensors. Light boxes of this kind, which are designed for detecting light of the wavelength of the optical distance sensor, make it possible to check whether the optical distance sensor is oriented correctly.

### SUMMARY

The object of the present invention is that of being able to carry out calibration of cameras and/or to carry out tests of systems that comprise at least one camera, in vehicles.

Claim 1 relates to a method for testing systems that comprise at least two cameras. The cameras are evaluated in a coordinated manner in order to capture three-dimensional scenes (or objects).

Claim 1 relates to a method for carrying out tests of systems of a vehicle that comprise at least two cameras for capturing images by means of the at least two cameras and for coordinated evaluation of the images captured by the at least two cameras for the purpose of three-dimensional assessment of the captured images. A three-dimensional object or a three-dimensional scene is simulated by means of the image display of a plurality of associated two-dimensional images, the number of which corresponds to the number of cameras of which the images are evaluated in a coordinated manner. Each of the associated two-dimensional images corresponds to the projection of the three-dimensional object or the three-dimensional scene into a plane perpendicular to the viewing direction of one of the cameras towards the simulated three-dimensional object or the three-dimensional scene. In the case of observation using the cameras involved, and subsequent evaluation and assessment of the images captured by the cameras involved, the associated images reproduce the three-dimensional object or the three-dimensional scene at the same timepoint.

The displays of the associated images can be separated, in accordance with an alternative of claim 1, by means of said images being displayed in temporal succession.

This advantageously makes a test possible even if the images that the cameras “see” are spatially superimposed on one another. A test can nonetheless be carried out by means of intervention in the evaluation of the camera images.

According to this alternative of claim 1, the camera images are advantageously evaluated in that said evaluation of the images of the individual cameras is temporally synchronized with the display of the images. It is thus possible for images of a camera to be evaluated only when an image belonging to said camera is also displayed.

This can be achieved by means of the images captured at time points at which images were displayed that do not belong to the relevant camera are suppressed during the evaluation of the images of the camera.

“Shutter glasses” are also known, for example from 3D television. The images that pass through can be synchronized accordingly, by means of said shutter glasses. One of said “shutter glasses” is assigned to each of the cameras, respectively, for the purpose of temporal synchronization of the images.

The displays of the associated images are separated, in a further alternative of claim 1, by means of said different images being displayed using light of different polarization directions and/or using light of different wavelengths. Each of the cameras is assigned a filter system that is a polarization filter and/or a color filter.

The configuration in accordance with this further alternative relates to a further possibility for separating the image displays. In this case, a corresponding filter is inserted upstream of the cameras in order to carry out the test.

Claim 2 relates to a vehicle test bench for carrying out tests of systems of a vehicle which comprise at least one camera. The vehicle test bench has a target position for the vehicle. At least one surface that reproduces an image display and/or shows an image display is assigned to the cameras of systems to be tested. Furthermore, a plurality of elements that absorb stray light are provided, which elements each consist of a wall-like boundary of the vehicle test bench, which reduces penetration of light into the vehicle test bench. Furthermore, defined light conditions for tests can be displayed using illumination units. A plurality of said wall-like boundaries results in lateral delimitation of the vehicle test bench on all sides. Furthermore, a supporting structure is provided comprising at least one elongate support element that is arranged above the vehicle. The vehicle test bench furthermore comprises adjustment means for moving at least one of the at least one surface reproducing an image display and/or showing an image display, and/or at least one unit for checking a radar sensor, and/or at least one unit for checking an optical distance sensor, and/or at least one unit for checking a night vision device of the vehicle in the horizontal direction along the at least one support element.

The systems that comprise at least one camera may be designed so as to comprise a plurality of cameras. The number of the cameras may be two for example. A system of this kind makes it possible for three-dimensional images and three-dimensional scenes to be captured and assessed using both cameras, by means of stereophotogrammetric image evaluation. Alternatively or in addition, the systems may be designed so as to comprise one or more radar sensors and/or one or more optical distance sensors.

The target position of the vehicle may be defined in that the vehicle test bench comprises a positioning system by means of which it is possible to exactly position the vehicle in the vehicle test bench. This can be achieved for example in that the vehicle is positioned exactly on a positioning unit.

Said exact positioning is intended to mean that the surface(s) reproducing an image display and/or showing an image display, and/or the unit for checking a radar sensor are oriented with respect to a common reference system, and that the position and orientation of the vehicle with respect to said common reference system is known.

This makes it possible to carry out calibration of the cameras and radar sensors based on the vehicle geometry or also on the geometric travel axis of the vehicle. Provided that the length of the geometric travel axis relative to the vehicle geometry is known, the location of the geometric travel axis of the vehicle can be determined from a defined location of the vehicle geometry.

The calibration can be carried out in that the relevant camera is shown a reference image.

The camera is adjusted automatically by means of control device communication.

Adjustment of front radar sensors: Measurement of the beam angle relative to the geometric travel axis, using a mirror. Automatic adjustment by means of control device communication, or manual adjustment by means of set screws.

Adjustment of optical distance sensors: Measurement of the beam angle relative to the geometric travel axis, using a light box. Automatic adjustment by means of control device communication, or manual adjustment by means of set screws.

Adjustment of the lateral radar sensors: Position acquisition of doppler generators and adjustment by means of control device communication.

The at least one surface may reproduce an image display when an image is projected onto the surface by means of an image display device (for example a projector), such that said image is shown on the surface. An image display can also be shown on the surface in that the surface is designed as a screen that is actuated such that the image is shown on the screen. It is also possible for a reference sample to be applied to the surface. Said surface is thus also a target within the meaning of this IP right.

In this case, an image may also consist of a plurality of partial images. It is possible, for example, to provide a large surface on which images for different cameras having different viewing angles are displayed side-by-side or one above the other, in a spatially separated manner.

A vehicle test bench of this kind makes it possible to identify whether images displayed on the at least one surface are accurately identified by the cameras of the systems of the vehicle.

This may relate to the question of whether the camera correctly identifies the image at all. This relates to the question of whether the camera has been correctly connected during installation. When testing a system, it is also possible to check whether control devices in the vehicle emit output signals in response to an identified reference image or an identified sequence of reference images, the target values of which output signals correspond to said reference image(s). This corresponds to an approach in which the systems emit notification or warning signals to vehicle drivers.

If the systems also intervene in adjustment means of a vehicle (acceleration, braking, steering) within the meaning of autonomous driving, a test of the overall system can also include the vehicle test bench further having the functionality of a steerable roller test bench. Regarding the design of a test bench of this kind, reference is made to the not previously published German patent application DE 10 2015 115 607.5. Using a steerable roller test bench makes it possible to identify whether the interventions in the adjustment systems of the vehicle take place for the reference image or the reference images, which interventions are provided for the corresponding reference image or the corresponding reference images. In the case of an overall system of this kind it is also possible to test parts of said overall system. For example, the functionality of a partial system can be tested in that the actuation signal for the adjustment means of the vehicle is compared with a target value that is dependent on the reference image or the reference images. For this purpose, said actuation signal has to be tapped from the overall system. During the function test, it is possible to carry out a separate check of the part of the overall system that relates to the capture of the reference image and the evaluation thereof, from the part of the overall system that relates to the mechanical actuator engineering of the adjustment means of the vehicle.

When checking whether the displayed images are accurately identified, it is also possible to carry out calibration of the cameras in the sense that the reference images or reference markings in the reference images are identified by the cameras in the correct direction with respect to the orientation of the vehicle.

The plurality of elements that absorb stray light advantageously increase the contrast of the image display and reduce the influence of stray light.

It has been found that more tightly the vehicle test bench is “encapsulated” with respect to stray light, the better the contrast of the image displays. Furthermore, additional illumination means may display defined light conditions. In this respect, reference is made to the embodiment according to claim 3.

Lateral delimitation of the vehicle test bench on all sides is achieved by means of a plurality of said elements that absorb stray light being provided, which elements each form a wall-like boundary.

The absorption of stray light can be improved if the walls are of a corresponding height. This applies in particular for an embodiment that is not closed at the top by means of a roof-like cover. If a roof-like cover of this kind is provided, a box results in any case that is more or less closed, and therefore the height of the side walls is no longer relevant for the absorption of stray light.

The more effectively said stray light is absorbed, the more it becomes possible to also calibrate and test night vision devices that are part of the vehicle.

The supporting structure of the vehicle test bench may also be used to carry the elements that absorb stray light, in addition to guiding at least one of the at least one surface reproducing an image display and/or showing an image display, and/or at least one unit for checking a radar sensor, during the movement thereof in the horizontal direction. A dual use of this kind of the supporting structure advantageously minimizes the structural outlay when designing the vehicle test bench.

The flexibility in the positioning has been found to be expedient because it is then possible to carry out calibration work and tests of various vehicle types in a flexible manner using the vehicle test bench, in that the positioning of at least one of the at least one surface reproducing an image display and/or showing an image display, and/or at least one unit for checking a radar sensor, can be adjusted to the relevant vehicle type.

It is furthermore possible to position at least one of the at least one surface reproducing an image display and/or showing an image display, and/or at least one unit for checking a radar sensor immediately in front of or behind the vehicle, when said vehicle is located in the vehicle test bench, in order to carry out the calibration and/or the tests. In order to drive the vehicle into the vehicle test bench and/or out of the vehicle test bench, the corresponding systems can be moved out of the traffic lane of the vehicle.

In the embodiment according to claim 3, illumination means are provided as a component of the vehicle test bench, for defined illumination of the interior of the vehicle test bench.

As a result, it is advantageously possible, when testing systems that comprise at least one camera, to test whether the system can sufficiently reliably identify a defined scene even in unfavorable light conditions. If the vehicle test bench is brightly illuminated in a defined manner, for example, it is possible to test for example whether bright objects can still be accurately identified in the display.

According to claim 4, the vehicle test bench comprises a measuring assembly which consists of measuring probes, wherein said measuring probes measure the position and/or orientation in the vehicle test bench of a vehicle located in the vehicle test bench, using optical means. The measuring assembly is movable such that the parts of the measuring assembly can be moved into a first position (measuring position) in the vehicle test bench at defined positions of the vehicle test bench, and such that the parts of the measuring assembly can be moved into a second position (calibration and/or testing position) that is outside the field of view of cameras that are part of systems to be tested.

It is furthermore possible to determine the vehicle position and the orientation of the vehicle using sensors belonging to the vehicle, and corresponding surfaces that are to be measured.

If radar sensors are also calibrated or included in the test during the calibration and/or test, the parts of the measuring assembly in the second position are also located outside the detection range of the radar sensors.

The measuring assembly first derives the position and/or the orientation of the vehicle in the vehicle test bench.

For this purpose, the parts of the measuring assembly are moved to defined positions in the vehicle test bench such that the alignment of the measuring probes is defined with respect to orientation and the position. As a result, said measuring probes are calibrated to the reference system of the vehicle test bench.

Furthermore, the at least one surface reproducing an image display and/or showing an image display is oriented in a position and or at an orientation in the vehicle test bench such that the reference system for the image display is oriented to the position and/or the orientation of the vehicle.

The measuring assembly may consist of measuring probes that are marketed by the applicant under the designation x-wheel for example. These are also described in the patent application WO 2010/025723 A1 for example.

In this case, it has been found to be advantageous for it to be possible for the measuring assembly to be removed after the vehicle has been measured. Advantageously, in this case the measuring assembly does not interfere with the subsequent tests of the cameras and optionally radar sensors. Interference of this kind may consist in parts of the measuring assembly being directly in the field of view of cameras or in the detection range of radar sensors that are intended to be calibrated and/or tested. Further interference may consist in the measuring assembly scattering light in the vehicle test bench, which may result in interference in the display of the images.

The target position of the vehicle in the vehicle test bench can be defined by a centering unit for the vehicle, as has already been described in conjunction with claim 1. In the case of an embodiment of this kind, according to claim 3 the purpose of the measuring assembly is also to check the position and orientation of the vehicle. When using the centering unit, in normal circumstances the target position of the vehicle corresponds to the actual position. Moreover, in this embodiment, in normal circumstances the target orientation corresponds to the actual orientation.

However, the target position of the vehicle may also be defined less precisely, for example in that markings are provided in the vehicle test bench that are used for orientation purposes for a worker who drives the vehicle into the vehicle test bench. In the case of an embodiment of this kind, the vehicle position and the vehicle orientation in the vehicle test bench are less precisely defined. Therefore, after the vehicle has been driven in, the position and/or orientation of the vehicle (actual position/actual orientation) is determined by means of the measuring assembly.

Claim 5 relates to a further embodiment of the vehicle test bench according to any of claims 2 to 4, by means of which it is possible to measure the position and/or orientation of the vehicle in the vehicle test bench. For this purpose, the vehicle test bench comprises reference objects which are located at defined positions in the vehicle test bench. Said reference objects can be captured by means of the vehicle's own sensors such that the position and/or orientation in the vehicle test bench of a vehicle located in the vehicle test bench is measured thereby.

Claim 5 describes a possibility for being able to carry out a measurement of the position and/or the orientation of the vehicle in the vehicle test bench in a manner requiring less structural outlay that in the case of the embodiment according to claim 4. It is merely necessary to position reference objects at defined positions in the vehicle test bench. Said reference objects may for example be markings on the walls of the vehicle test bench which remain permanently at said positions. Said markings may be targets that are captured by the relevant sensors belonging to the vehicle. Markings of this kind can be measured by means of cameras that are installed in the vehicle. The reference objects may also be three-dimensional objects. It is thus possible to also measure said objects using radar sensors of the vehicle or using optical distance sensors.

The embodiment according to claim 5 can be implemented alternatively or in addition to the embodiment of the measurement of the vehicle according to claim 4.

In the embodiment according to claim 5, it is necessary for the sensors of the vehicle by means of which the position and/or the orientation of the vehicle in the vehicle test bench is intended to be determined to already be calibrated.

In the embodiment according to claim 6, the vehicle test bench comprises a control unit for actuating the adjustment means for moving at least one of the at least one surface reproducing an image display and/or showing an image display, and/or at least one unit for checking a radar sensor, and/or at least one unit for checking an optical distance sensor in the horizontal direction along the at least one support element, depending on an identified actual position and/or an identified actual orientation of the vehicle in the test bench.

This embodiment makes it possible to position the at least one surface reproducing an image display and/or showing an image display, and/or at least one unit for checking a radar sensor in a manner dependent on the actual position and/or the actual orientation of the vehicle, such that the at least one surface reproducing an image display and/or showing an image display, and/or at least one unit for checking a radar sensor, is located in the detection range of the relevant sensor of the vehicle.

If, in this case, the surface is a surface that reproduces an image, in which the image is projected by means of a projector, or a surface that shows an image, in the form of a screen, the positioning of the corresponding surface may already be sufficient. This applies in particular if the display of the image is adjusted to the orientation of the vehicle in that the image is reproduced by the surface so as to be correspondingly distorted. In this case, the distortion factor depends on the orientation of the surface relative to the orientation of the vehicle.

The orientation of the vehicle relative to the vehicle test bench is known from the centering unit or from the measuring assembly. The orientation of the surfaces for the image reproduction or image display is also known from the reference system of said surfaces in the vehicle test bench. The distortion factor for the image display can be directly determined therefrom.

Claim 7 relates to an embodiment of the vehicle test bench in which positioning means are provided for adjusting the orientation of at least one of the at least one surface reproducing an image display and/or showing an image display, and/or at least one unit for checking a radar sensor, and/or at least one unit for checking an optical distance sensor.

In this case, the orientation of the systems is adjusted to the orientation of the vehicle. This has been found to be advantageous in particular in the case of a unit for checking a radar sensor. Said units return reflected beams, or altered beams having a frequency shift, to the relevant sensor. In order for these beams to also strike the relevant sensor of the vehicle, the orientation of the corresponding units has to be aligned to the orientation of the vehicle.

If the surfaces that reproduce an image display or show an image display are also rotated, such that the orientation thereof is adjusted to the orientation of the vehicle, the images do not have to be converted by a distortion.

In the embodiment according to claim 8, a roof-like boundary of the vehicle test bench is furthermore provided, which boundary reduces penetration of light into the vehicle test bench.

The influence of stray light is further minimized thereby.

In the embodiment according to claim 9, at least one opening is provided that can be closed by a cover and is intended for the purpose of driving a vehicle into the vehicle test bench and/or out of the vehicle test bench. In this case, the inner surface of the cover is one of the at least one surface reproducing an image display and/or showing an image display.

The cover can also be designed as a roller door or as a ceiling track door or as an overhead door. It is also possible to move the cover laterally in order to open and close the entrance or the exit. It has been found to be advantageous for image display if the cover is not formed in sections but is instead a coherent surface, at least in the closed state. For this purpose, it may be possible for the cover to be rolled up, for example, in that said cover is designed in a manner comparable to a screen, as is known from the presentation of reversal films. In the closed state, the cover is in this case advantageously tensioned in order to achieve a defined plane for the image display. The cover may for example also consist of a foil that is provided for electrical actuation for active image output. Foils of this kind are known as OLED foils that consist of organic materials.

Claim 10 relates to a method for carrying out the calibration and/or tests of systems of a vehicle which comprise at least one camera, using a vehicle test bench according to any of the preceding claims. The orientation of the vehicle is known from the positioning and centering system and/or from the measurement using the measuring assembly.

In a first configuration of the method of claim 10, the reference system of the image display is oriented to the orientation of the vehicle, in that the at least one surface reproducing an image display and/or showing an image display is oriented according to the orientation of the vehicle.

The approach in particular makes use of the embodiment of the vehicle test bench according to claim 7, provided that the positioning means are also designed, therein, for adjusting the orientation of at least one of the at least one surface reproducing an image display and/or showing an image display.

The advantages have already been explained in conjunction with claim 7.

In a further configuration of the method of claim 10, the reference system of the image display is oriented to the orientation of the vehicle in the vehicle test bench, in that the image display is reproduced and/or shown on the at least one surface reproducing an image display and/or showing an image display in a manner having a distortion that is dependent on the orientation of the surface relative to the orientation of the vehicle.

In this configuration, it has been found to be advantageous that the structural embodiment of the test bench is simplified, because the number of degrees of freedom for a movement of the surfaces for image display can be reduced. In particular, the surfaces can be mounted in the vehicle test bench so as to be fixed in position and so as to have a defined orientation. The adjustment to the relevant orientation and position of the vehicle in the test bench is carried out by means of the image display being converted and adjusted accordingly. Even if the vehicle test bench is designed such that the surfaces are movable in the horizontal direction, it has still been found to be advantageous, from a structural perspective, for the orientation of the surfaces not to be rotatable (about the vertical axis). Reference is also made to the corresponding explanations in connection with claim 6.

According to claim 11, it is within the scope of the present invention to use a vehicle test bench according to any of claims 2 to 9 in order to carry out the method according to claim 1. The vehicle test bench is configured to test systems that comprise multiple cameras, wherein three-dimensional images as well as three-dimensional scenes can be captured and evaluated by means of such a system.

It has been found to be advantageous, in all embodiments of the vehicle test bench, that no pit is necessary for sinking the corresponding parts of the vehicle test bench, despite the movable design of parts of the vehicle test bench. If parts of the vehicle test bench need to be moved, this is achieved in that said parts are moved in the horizontal direction or upwards.

### BRIEF DESCRIPTION OF THE DRAWINGS

An embodiment of the invention is shown in the drawings. In said drawings:

FIG. 1: is a perspective view of a vehicle test bench comprising an open entrance opening for a vehicle,

FIG. 2: is a perspective view of a vehicle test bench comprising an open entrance opening and an open roof,

FIG. 3: is a perspective view of a vehicle test bench comprising an open roof and without side walls,

FIG. 4: is a plan view of a vehicle test bench comprising an open roof,

FIG. 5: shows a first embodiment of temporal separation of the display of images that are associated with one another as a stereophotogrammetric display of a three-dimensional structure, and

FIG. 6: shows a further embodiment of temporal separation of the display of images that are associated with one another as a stereophotogrammetric display of a three-dimensional structure.

### DETAILED DESCRIPTION

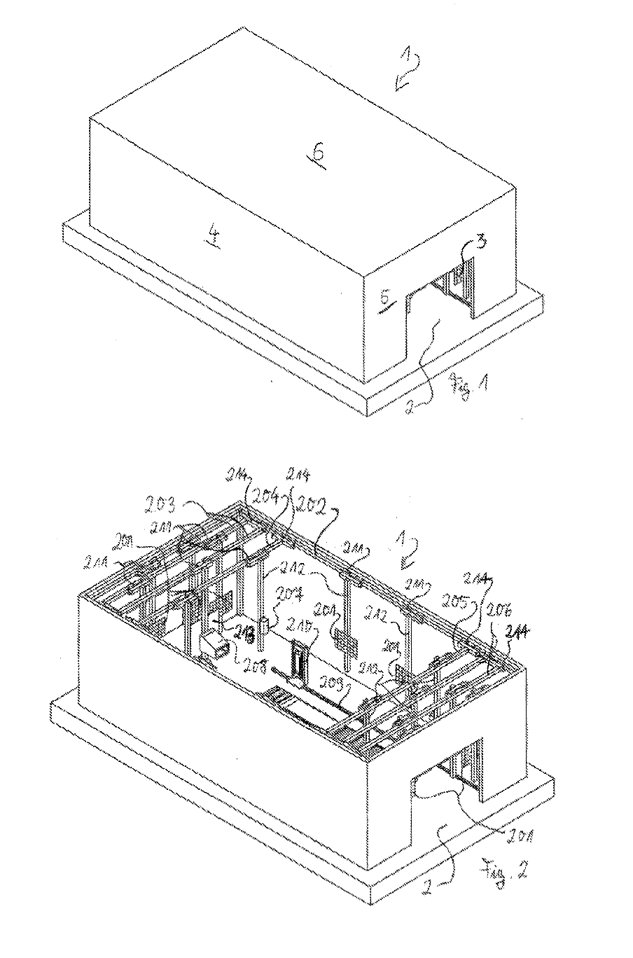

FIG. 1 is a perspective view of a vehicle test bench 1 comprising an open entrance opening 2 for a vehicle.

Suspension means and a portion of a surface 3 reproducing an image display and/or showing an image display can be seen through the open entrance opening 2. Said elements of the vehicle test bench will be explained in greater detail in the following figures.

The perspective view in FIG. 1 shows two side walls 4 and 5 of the vehicle test bench 1, as well as a roof-like cover 6 of the vehicle test bench 1.

The side walls 4 and 5 (and the further side walls which are not visible in the perspective view of FIG. 1) reduce the penetration of light into the vehicle test bench.

The roof-like cover 6 further reduces the penetration of light from the outside into the vehicle test bench 1.

This results in good contrast of the displayed images in the vehicle test bench for calibrating cameras of the vehicle and for testing systems of the vehicle, in which said cameras are part of the systems.

FIG. 2 is a perspective view of a vehicle test bench 1 comprising an open entrance opening 2 and an open roof.

A supporting structure can be seen which comprises elongate support elements 202 that extend horizontally in the longitudinal direction of the vehicle test bench 1.

The elongate support elements 202 that extend in the longitudinal direction of the vehicle test bench 1.

Fastening elements 212 can be moved, by means of guide elements 211, along said elongate support elements 202 in that the guide elements 211 are displaceable along the support element 202. Targets 201, 207, 208, 213 are fastened to the fastening elements 212. The targets 201 are the surfaces for image display for the cameras, the targets 207 are doppler generators for lateral radar sensors, the targets 208 are light boxes for the optical distance sensors, and the targets 213 are mirrors for the front radar sensors.

The fastening elements 212 are vertical rods to which the targets 201, 207, 208, 213 are fastened.

At least the fastening elements 212 to which doppler generators 207, mirrors 213 or light boxes 208 are fastened can advantageously be rotated about the vertical axis in order for it to be possible to orient the corresponding targets 207, 208, 213 to the geometric travel axis of the vehicle.

It can be seen that the light boxes 208 and the mirrors 213 are attached to the same fastening element 212. It is thus possible to rotate one of the targets 208, 213 towards the vehicle in order to carry out the calibration or to carry out tests, by means of said fastening element 212 being rotated a corresponding amount (up to 180°).

It is also possible to orient the targets by means of the individual targets being assigned their own rotation mechanism. This has been found to be advantageous in particular when a plurality of targets are attached to the same fastening element 211. The targets can then be mutually independently oriented with respect to the vehicle.

It can furthermore be seen that further support element 203, 204, 205, 206 are attached to the support element 202 by means of guide elements 214. Said support elements 203, 204, 205, 206 also extend in the horizontal direction, albeit transversely to the longitudinal direction of the vehicle test bench 1. As a result of the fastening by means of the guide elements 214, the support elements 203, 204, 205, 206 are displaceable along the support elements 202 in the longitudinal direction of the vehicle test bench 1.

Further fastening elements 212, to which targets 201, 207, 208, 213 are attached, are in turn attached to the support elements 203, 204, 205, 206 by means of guide elements 211.

Furthermore, a rail 209 can in addition be seen in the drawing according to FIG. 2, which rail is arranged in the base region of the vehicle test bench 1. A measuring probe 210, by means of which the location and the orientation of the vehicle in the vehicle test bench 1 can be measured, is displaceable along said rail 209. For this purpose, the measuring probe 210 can be moved to defined positions along the rail 209 in order for example to capture the location of characteristic points of the vehicle body and/or the parameters of the vehicle geometry such as the toe and camber angle of the wheels of the vehicle.

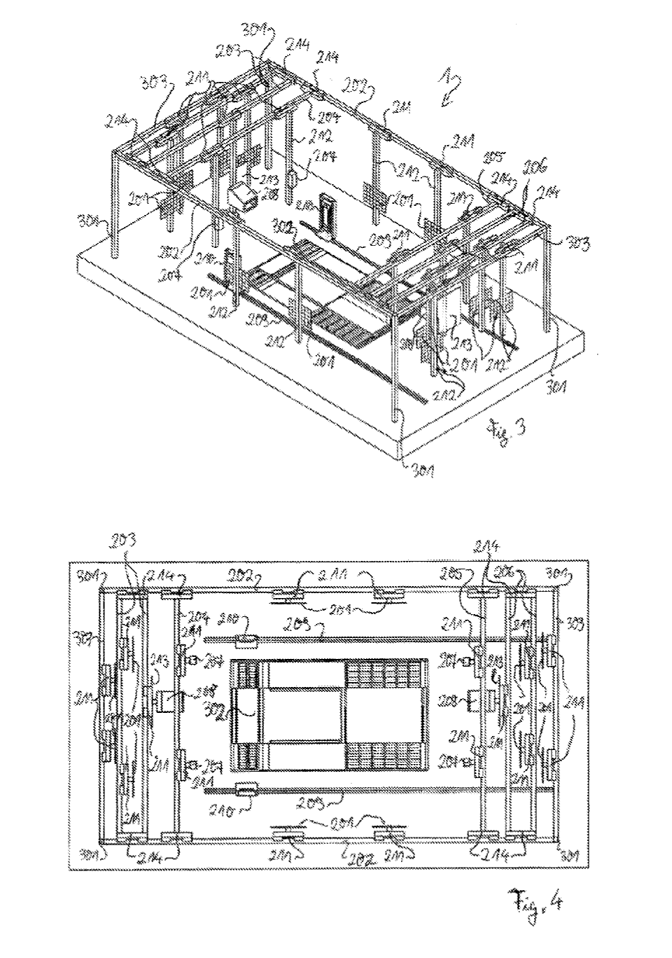

FIG. 3 is a perspective view of a vehicle test bench 1 comprising an open roof and without side walls. Parts that are identical to those in the drawing according to FIG. 2 have been provided with identical reference signs.

It can be seen that the vehicle test bench is mirror-symmetric.

In a manner supplementing the drawing according to FIG. 2, it can be seen that four props 301 are provided at the corners of the vehicle test bench 1. Said props carry the support elements 202 and the support elements 303.

The supporting structure of the vehicle test bench 1 is defined thereby. The fastening elements 212 are fastened to the support elements 202, 303 and the support elements 203, 204, 205 and 206 by means of the guide elements 211 such that the fastening elements 212 are displaceable along the support elements. Said fastening elements end above the base.

At least some of the fastening elements 212 are also rotatable about the vertical axis.

The vehicle test bench 1 further comprises a positioning system 302. When the vehicle drives onto said positioning system 302, the vehicle body is in a defined orientation and also a defined position with respect to the vehicle test bench 1.

The side walls and, if provided, also a roof-like cover of the vehicle test bench 1 can be fastened to said supporting structure.

FIG. 4 is a plan view of a vehicle test bench 1 comprising an open roof, Parts that are identical to those in FIGS. 1 to 3 have again been provided with identical reference signs.

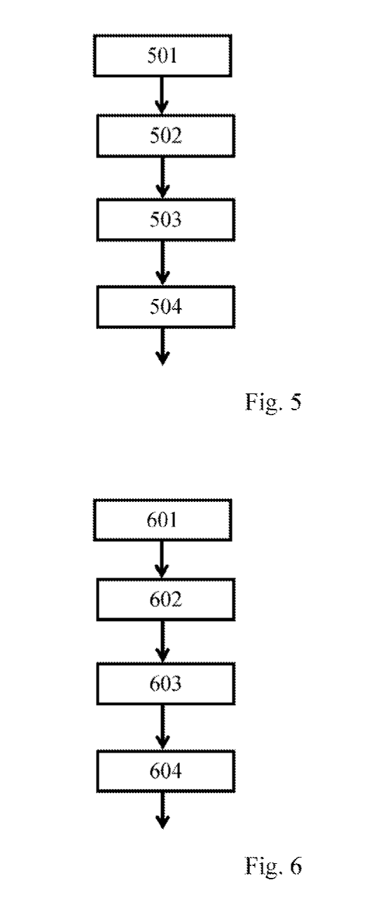

FIG. 5 shows a first embodiment of temporal separation of the display of images that are associated with one another as a stereophotogrammetric display of a three-dimensional structure. In the embodiment shown, a sequence consisting of a synchronization image and a subsequent image display is shown alternately for the left-hand camera and the right-hand camera. The block 501 denotes the synchronization image for the left-hand camera. The block 502 denotes the image display of the first scene for the left-hand camera. The block 503 denotes the synchronization image for the right-hand camera. The block 504 denotes the image display of the first scene for the right-hand camera. Subsequently, the synchronization image for the left-hand camera is again displayed, then the image display of the second scene for the left-hand camera, then the synchronization image for the right-hand camera, and then the image display of the second scene for the right-hand camera, etc.

During the evaluation of the image sequence, it is possible to identify, from the respective synchronization images 501 and 503, whether the subsequent image display 502 and 504, respectively, is to be assigned to the left-hand camera or to the right-hand camera.

During the image evaluation, it is possible to take account only of the corresponding image displays that are assigned to the relevant camera.

As a result of the stereophotogrammetric evaluation, both cameras identify the entire scene in a three-dimensional manner.

FIG. 6 shows a further embodiment of temporal separation of the display of images that are associated with one another as a stereophotogrammetric display of a three-dimensional structure. In contrast to the embodiment of FIG. 5, in this case the images that are associated in pairs are not displayed in immediate succession. Instead, the complete scene is first shown for the display of the left-hand camera. This display also begins again with a synchronization image for the left-hand camera. This corresponds to function block 601. Subsequently, function block 602 does not correspond to the display of a single image, but instead to the display of the image sequence of the scene from the viewing direction of the left-hand camera. Subsequently, starting with a synchronization image for the right-hand camera corresponding to function block 603, the corresponding scene is shown, in a manner corresponding to function block 604, from the viewing direction of the right-hand camera. During the evaluation of the image sequences, the synchronization images 601 and 603 make it possible to separate which of the image sequences 602 and 604 are associated with which of the cameras.

The drawings in FIGS. 5 and 6 relate to embodiments for carrying out tests of the cameras using the evaluation units. The evaluation units therefore have a working mode in which the images of the cameras are continuously evaluated as they were acquired. FIGS. 5 and 6 relate to a mode of operation in a test mode, in which the evaluation of the cameras is synchronized such that only those images are evaluated that are assigned to the corresponding cameras.

1. Method for carrying out tests of systems of a vehicle that comprise at least two cameras for capturing images by means of the at least two cameras and for coordinated evaluation of the images captured by the at least two cameras for the purpose of three-dimensional assessment of the captured images, in particular a vehicle test bench according to any of claims 1 to 8,
characterized in that a three-dimensional object or a three-dimensional scene is simulated by the image display of a plurality of associated two-dimensional images, the number of which corresponds to the number of the cameras, the images of which are evaluated in a coordinated manner, wherein each of the associated two-dimensional images corresponds to the projection of the three-dimensional object or the three-dimensional scene into a plane perpendicular to the viewing direction of one of the cameras towards the simulated three-dimensional object or the three-dimensional scene, wherein the associated images display the three-dimensional object or the three-dimensional scene at the same timepoint, and in that the displays of the associated images are separated by means of said images being displayed in temporal succession.

2. Method for carrying out tests of systems of a vehicle that comprise at least two cameras for capturing images by means of the at least two cameras and for coordinated evaluation of the images captured by the at least two cameras for the purpose of three-dimensional assessment of the captured images, in particular a vehicle test bench according to any of claims 1 to 8,
characterized in that a three-dimensional object or a three-dimensional scene is simulated by the image display of a plurality of associated two-dimensional images, the number of which corresponds to the number of the cameras, the images of which are evaluated in a coordinated manner, wherein each of the associated two-dimensional images corresponds to the projection of the three-dimensional object or the three-dimensional scene into a plane perpendicular to the viewing direction of one of the cameras towards the simulated three-dimensional object or the three-dimensional scene, wherein the associated images display the three-dimensional object or the three-dimensional scene at the same timepoint, and in that the displays of the associated images are separated by means of said different images being displayed using light of different polarization directions and/or using light of different wavelengths, wherein each of the cameras is assigned a filter system that is a polarization filter and/or a color filter.

3. Vehicle test bench (1) for calibrating and/or testing systems of a vehicle which comprise at least one camera,
characterized in that the vehicle test bench (1) has a target position (302) for the vehicle, in that at least one surface (201) that reproduces an image display and/or shows an image display is assigned to the cameras of systems to be tested,
in that a plurality of elements (4, 5) that absorb stray light are provided, which elements each consist of a wall-like boundary (4, 5) of the vehicle test bench, which reduces penetration of light into the vehicle test bench (1), wherein a plurality of wall-like boundaries (4, 5) results in lateral delimitation of the vehicle test bench on all sides, in that a supporting structure (301, 202, 303) is provided comprising at least one elongate support element (202, 303, 203, 204, 205, 206) that is arranged above the vehicle, as well as adjustment means for moving at least one of the at least one surface (201) reproducing an image display and/or showing an image display, and/or at least one unit (207, 213) for checking a radar sensor of the vehicle, and/or at least one unit (208) for checking an optical distance sensor of the vehicle, and/or at least one unit for checking a night vision device of the vehicle in the horizontal direction along the at least one support element.

4. Vehicle test bench according to claim 3,
characterized in that illumination means are provided as a component of the vehicle test bench (1), for defined illumination of the interior of the vehicle test bench (1).

5. Vehicle test bench according to claim 3 or 4,
characterized in that the vehicle test bench (1) comprises a measuring assembly (209, 210) which consists of measuring probes (210), wherein said measuring probes (210) measure the position and/or orientation in the vehicle test bench (1) of a vehicle located in the vehicle test bench (1), using optical means, and
in that the measuring probes (210) are movable such that the measuring probes (210) can be moved into a first position (measuring position) in the vehicle test bench (1) at defined positions of the vehicle test bench (1), and such that the measuring probes can be moved into a second position (calibration and/or testing position) that is outside the field of view of cameras that are part of systems to be tested.

6. Vehicle test bench according to any of claims 3 to 5,
characterized in that the vehicle test bench (1) comprises reference objects which are located at defined positions in the vehicle test bench, and
in that said reference objects can be captured by means of the vehicle's own sensors such that the position and/or orientation in the vehicle test bench (1) of a vehicle located in the vehicle test bench (1) is measured thereby.

7. Vehicle test bench according to any of claims 3 to 6,
characterized in that a control unit is provided for actuating the adjustment means for moving at least one of the at least one surface (201) reproducing an image display and/or showing an image display, and/or at least one unit for checking a radar sensor (207, 213), and/or at least one unit (208) for checking an optical distance sensor in the horizontal direction along the at least one support element (202, 303, 203, 204, 205, 206), depending on an identified actual position and/or an identified actual orientation of the vehicle in the test bench.

8. Vehicle test bench according to any of claims 3 to 7,
characterized in that positioning means (212) are provided for adjusting the orientation of the at least one surface (201) reproducing an image display and/or showing an image display, and/or at least one unit (207, 213) for checking a radar sensor, and/or at least one unit (208) for checking an optical distance sensor.

9. Vehicle test bench according to any of claims 3 to 8,
characterized in that a roof-like boundary (6) of the vehicle test bench (1) is furthermore provided, which boundary reduces penetration of light into the vehicle test bench (1).

10. Vehicle test bench according to any of claims 3 to 9,
characterized in that at least one opening (2) is provided that can be closed by a cover and is intended for the purpose of driving a vehicle into the vehicle test bench (1) and/or out of the vehicle test bench (1), wherein the inner surface of the cover is one of the at least one surface (201) reproducing an image display and/or showing an image display.

11. Method for carrying out the calibration and/or tests of systems of a vehicle which comprise at least one camera, using a vehicle test bench according to any of claims 3 to 10,
characterized in that the reference system of the image display is oriented to the orientation of the vehicle, in that the at least one surface (201) reproducing an image display and/or showing an image display is oriented according to the orientation of the vehicle (212).

12. Method for carrying out the calibration and/or tests of systems of a vehicle which comprise at least one camera, using a vehicle test bench according to any of claims 3 to 10,
characterized in that the reference system of the image display is oriented to the orientation of the vehicle in the vehicle test bench by means of the image display being reproduced and/or shown on the at least one surface (201) reproducing an image display and/or showing an image display in a manner having a distortion that is dependent on the orientation of the surface (201) relative to the orientation of the vehicle.

13. Use of a vehicle test bench according to any of claims 3 to 10 in order to carry out one of the methods according to claim 1 or 2.
